(19) United States
(12) Patent Application Publication
(10) Pub. No.: US 2026/0045862 A1
(43) Pub. Date: Feb. 12, 2026

(54) INDUCTION MOTOR INCLUDING TELEMETRY UNIT FIXED TO ROTOR

(71) Applicant: Schaeffler Technologies AG & Co. KG, Herzogenaurach (DE)

(72) Inventor: Jacob Sheradin, North Canton, OH (US)

(21) Appl. No.: 18/801,442

(22) Filed: Aug. 12, 2024

(51) Int. Cl. H02K 17/16; H02K 11/00; H02K 11/25; H02K 11/33; H02K 11/35

(52) U.S. Cl. CPC H02K 17/168; H02K 11/0094; H02K 11/25; H02K 11/33; H02K 11/35

(57) ABSTRACT

An induction motor is includes a stator and a rotor configured for being rotated by the stator about a center axis The rotor includes a rotor bar assembly including a plurality of electrically conductive rotor bars. The motor also includes a telemetry device fixed to the rotor. The telemetry device is electrically connected to the rotor bar assembly and powered by a voltage difference along the rotor bar assembly during rotation of the rotor about the center axis. The rotor is rotated by a magnetic field of the stator inducing an electric current in the rotor bars. The motor also includes at least one sensor fixed to the rotor for measuring a parameter of the rotor. The telemetry device is configured for transmitting information representative of measurements of the at least one sensor to a controller located outside of the rotor.

The present disclosure relates generally to induction motors and more specifically to measuring parameters of rotors of induction motors.

### BACKGROUND

Induction motors can have a squirrel cage design, with iron laminations inserted along a plurality of individual bars making up the squirrel cage. Induction motor stators are of typically polyphasic construction and have phase terminals through which current flows in or out of the stator. Phase terminals are connected to a power electronics unit (PEU) which consists of sensors, transistors, etc. to modulate the current flow in or out of the stator.

### SUMMARY OF THE INVENTION

An induction motor is provided, including a stator; a rotor configured for being rotated by the stator about a center axis, the rotor including a rotor bar assembly including a plurality of electrically conductive rotor bars; a telemetry device fixed to the rotor, the telemetry device being electrically connected to the rotor bar assembly and powered by a voltage difference along the rotor bar assembly during rotation of the rotor about the center axis, the rotor being rotated by a magnetic field of the stator inducing an electric current in the rotor bars; and at least one sensor fixed to the rotor for measuring a parameter of the rotor, the telemetry device configured for transmitting information representative of measurements of the at least one sensor to a controller located outside of the rotor.

In examples, the telemetry device includes a first electrical connector connected to a first location of the rotor bar assembly and a second electrical connector connected to a second location of the rotor bar assembly, the first location having a different voltage than the second location.

In examples, the first location and the second location are on a single one of the rotor bars, the second location being axially offset from the first location.

In examples, the first location is on a first of the rotor bars and the second location being on a second of the rotor bars.

In examples, the parameter of the rotor is a temperature.

In examples, the rotor includes a metal core, the rotor bars being circumferentially spaced apart from each other by the metal core so that the rotor bars are contiguous with and extending along the metal core.

In examples, the rotor includes a rotor shaft, the metal core and the rotor bars being supported on the rotor shaft, the telemetry device being fixed to the rotor shaft.

In examples, the at least one sensor is fixed to the rotor shaft, the rotor bars, the metal core or a bearing of the rotor shaft.

In examples, an induction motor further including a power electronics unit fixed with respect to the stator, the power electronics unit including the controller, the controller configured to modulate a current flow in and out of phase terminals of the stator in response to measurements of the at least one sensor.

In examples, the information representative of measurements of the at least one sensor transmitted to the controller is transmitted via a voltage and/or a current of the phase terminals, the controller configured to modulate the current flow in and out of phase terminals of the stator in response to the obtained information about the voltage and/or current of the phase terminals.

In examples, the telemetry device is configured for transmitting the information representative of measurements of the at least one sensor to the controller by a varying the electrical connection to the rotor bar assembly.

In examples, the telemetry device includes a switched transistor configured to vary the electrical connection to the rotor bar assembly by opening and closing.

In examples, the switched transistor encodes the information from the measurements into a pulse pattern is opened and closed in accordance with the pulse pattern.

A method of operating the induction motor includes powering the telemetry device by the voltage difference; measuring, by the at least one sensor, the parameter of the rotor; and transmitting, by the telemetry device, information representative of measurements of the at least one sensor to the controller.

In examples, the method further includes modulating, by the controller, a flow of electrical current in and out of phase terminals of the stator as a function of the temperature and/or the voltage.

A method is also provided of constructing an induction motor rotor assembly including: fixing a telemetry device to a rotor configured for being rotated by a stator about a center axis, the rotor including a rotor bar assembly including a plurality of electrically conductive rotor bars; electrically connecting the telemetry device to a first location of the rotor bar assembly and to a second location of the rotor bar assembly so the stator generates a voltage difference along the rotor bar assembly during rotation of the rotor by a magnetic field of the stator inducing an electric current in the rotor bars; and fixing at least one sensor to the rotor; connecting the at least one sensor to the telemetry device for the telemetry device to transmit information representative of measurements of the at least one sensor to a controller located outside of the rotor.

### BRIEF DESCRIPTION OF THE DRAWINGS

The present disclosure is described below by reference to the following drawings, in which:

FIG. 1a shows a rotor bar assembly for a rotor of an induction motor;

FIG. 1b shows a metal core for a rotor of the induction motor;

FIG. 1c shows the rotor, with the rotor bar assembly and metal core on a rotor shaft;

FIG. 1d schematically shows a cross-section view of the induction motor; and

FIG. 2 schematically shows a telemetry device for installation of the rotor.

### DETAILED DESCRIPTION

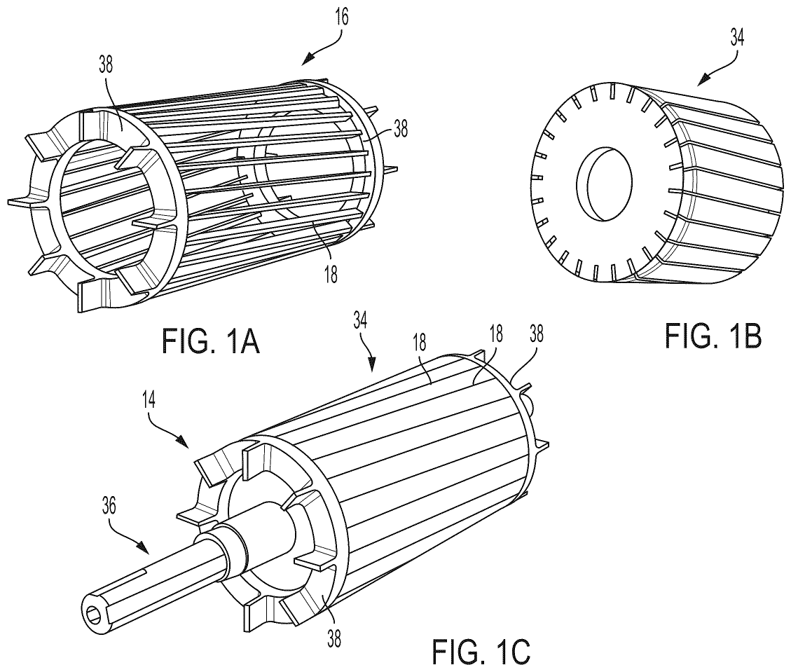

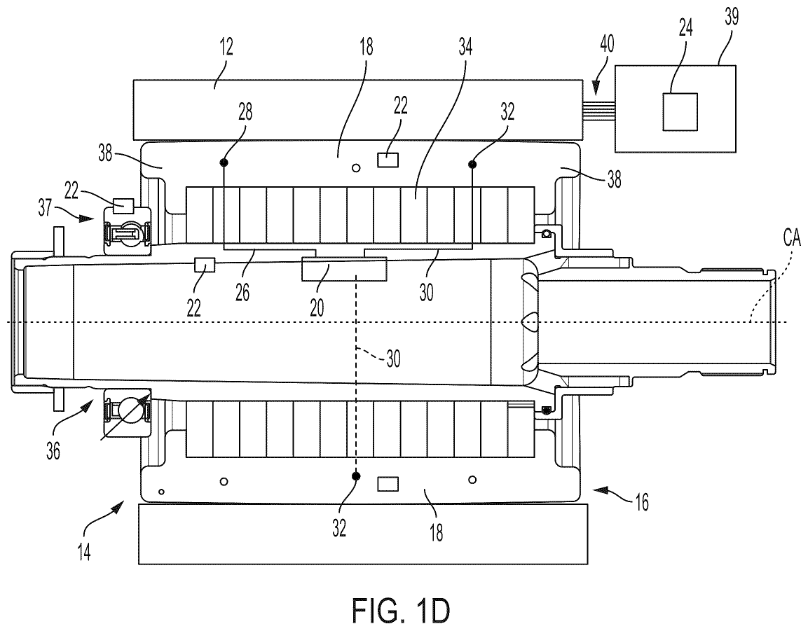

FIGS. 1a to 1d shown components of an induction motor 10. As illustrated in FIG. 1d, the induction motor 10 includes a stator 12 and a rotor 14 configured for being rotated by the stator 12 about a center axis CA. Unless otherwise specified, the terms axial, radial, circumferential and derivatives thereof refer to center axis CA. As illustrating in FIGS. 1a to 1c, the rotor 14 includes a rotor bar assembly 16 including a plurality of electrically conductive rotor bars 18. The rotor 14 is rotated by a magnetic field of the stator 12 inducing an electric current in the rotor bars 18. During normal operation of motor 10, as rotor 14 is rotated, there is a voltage difference along an axial length of each of the rotor bars 18, and also between different rotor bars 18.

The rotor bars 18 change in temperature based on environmental conditions and operating point (torque, speed, etc.). The voltages along the rotor bars 18 and temperature of the bar can thus provide useful information for the control strategy of the motor 10, as conventionally the voltages and temperature are not directly known during normal operation and are instead calculated guesses based on operating points. Without having measurements of the voltages and temperature exactly, the operating point and control strategy are never perfectly optimal. The motor 10 of the present disclosure solves the problem of directly measuring these values while the rotor 14 is moving relative to the rest of the motor 10, including control circuitry of a power electronics unit 39.

In order to help solve this problem, a telemetry device 20 is fixed to the rotor 14. The telemetry device 20 is electrically connected to the rotor bar assembly 16 and powered by the voltage difference along the rotor bar assembly 16 during rotation of the rotor about the center axis CA. The at least one sensor 22 is also powered by this voltage difference.

At least one sensor 22 is fixed to the rotor 14 for measuring a parameter of the rotor 14. The telemetry device 20 is configured for transmitting information representative of measurements of the at least one sensor 22 to a controller 24 located outside of the rotor 14.

The telemetry device 20 also includes a first electrical connector 26 connected to a first location 28 of the rotor bar assembly 16 and a second electrical connector 30 connected to a second location 32 of the rotor bar assembly 16. There is a voltage difference between the first location 28 and the second location 32. The power draw from rotor bars 18 is not great enough to meaningfully impactor performance of the induction motor 10. The electrical connectors 26, 30 can be electrically shielded wires.

In one embodiment, the first location 28 and the second location 32 can be on a single one of the rotor bars 18, as shown in FIG. 1d, with the first location 28 being axially offset from the second location 32. In another embodiment, the first location 28 can be on a first of the rotor bars 18 and the second location 32 is on a second of the rotor bars 18, as shown by dashed line in FIG. 1d.

The rotor 14 includes an electrical metal core 34, which can be formed as a high permeability electrical steel lamination stack. The rotor bars 18 are circumferentially spaced apart from each other by the metal core 34 so that the rotor bars 18 are contiguous with and extend along the metal core 34.

The rotor 14 also includes a rotor shaft 36 coincident with center axis CA. The metal core 34 and the rotor bars 18 are non-rotatably supported on the rotor shaft 36 Rotor 14 is non-rotatably fixed to a rotor shaft 16, with rotor 14 and rotor shaft 16 being rotatable together within stator 12 about the center axis CA in a known manner. The telemetry device 20 can advantageously be fixed to the rotor shaft 36, more specifically inside of the rotor shaft 36, to minimize forces on the telemetry device 20.

The at least one sensor 22 can also be fixed to the rotor shaft 36, the rotor bars 18, metal core 34 or a bearing 37 of the rotor shaft for measuring at least one parameter of the rotor 14. Sensors 22 can measure parameters including temperature, voltage and vibration. The sensors 22 can be temperature sensors, including thermocouples or thermistors, can be accelerometers such as MEMs, or can be voltages sensors. For example, rotor bar current can then be calculated with high accuracy based on the voltage and temperature of the rotor bar(s) 18.

For example, as illustrated schematically in FIG. 1, a sensor 22 can be temperature sensor fixed to an inner circumferential surface of the rotor shaft 36 for measuring a temperature of cooling fluid flowing inside of the rotor shaft 36. A sensor 22 can also be temperature sensor fixed to bearing 37 for measuring a temperature of bearing 37. A sensor 22 can also be an accelerometer fixed to bearing 37 for measuring a vibration of bearing 37. A sensor 22 can also be temperature sensor fixed to rotor bars 18 for measuring a temperature of rotor bars 18. A sensor 22 can also be temperature sensor attached to or embedded in the metal core 34 for measuring a temperature of metal core 34.

The rotor 14 is a squirrel cage rotor and further includes electrically conductive end segments 38. Rotor bars 18 extend along the metal core 34 and end segments 38 are formed onto opposite ends of the rotor bars 20. The rotor bars 18 are electrically conductive and provide a path for the flow of current within rotor 14. Rotor bars 18 are shorted at the ends by end segments 38, forming a closed loop. When the motor 10 is energized, a magnetic field of the stator 12 induces an electric current in the rotor bars 18. Metal core 34 provides a path for the magnetic flux generated by windings of stator by channeling the magnetic field produced by the stator 12 to the rotor bars 18. The electrically conductive metal of rotor bar assembly 16, i.e., rotor bars 18 and end segments 38, is contiguous with the electric metal core 34 and the electrically conductive metal can be joined with metal core 34 by casting to form rotor bars 18 and end segments 38.

The induction motor 10 further includes a power electronics unit 39 fixed with respect to the stator 12. The power electronics unit 39 includes the controller 24 configured to modulate a current flow in and out of phase terminals 40 of the stator 12 in response to measurements of the at least one sensor 22.

The controller 24 is configured to obtain information about a voltage and/or current of the phase terminals 40 and to modulate the current flow in and out of phase terminals 40 of the stator 12 in response to measurements of the at least one sensor 22 and the obtained information about a voltage and/or current of the phase terminals 40.

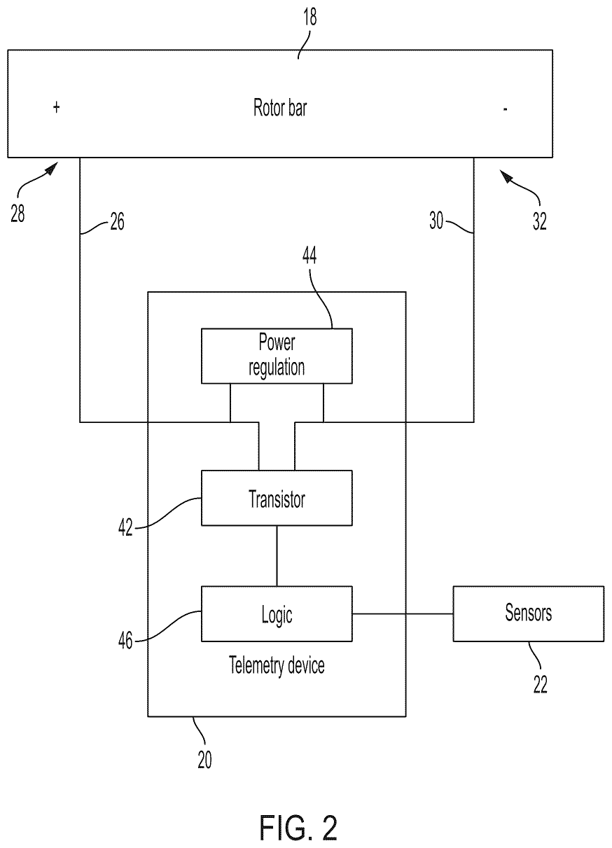

The telemetry device 20 is configured for transmitting the information representative of measurements of the at least one sensor 22 to the controller 24 by a varying the electrical connection to the rotor bar assembly 16. For this purpose, as illustrated in FIG. 2, the telemetry device 20 can include a switched transistor 42 configured to vary the electrical connection to the rotor bar assembly 16 by opening and closing at different frequencies. The switched transistor encodes the information from the measurements from the at least one sensor 22 into a pulse pattern is opened and closed in accordance with the pulse pattern to achieve a controlled redirection of the current along the rotor bar assembly 16.

When the transistor 42 is closed, the effective resistance of the rotor bar assembly 16 is lower. A ballast, for example a resistor, a diode or an inductor, may be added in series with the transistor 42 to regulate the amount of current that is redirected. For example, multiple electrical connectors 26, 30 at multiple locations along the length of the rotor bar 14 and multiple switched transistors may be used to ensure an appropriate amount of current shunting takes place. Too much current might damage circuitry or impact operation of the motor, while too little might not result in sufficient signal-noise ratio. This effective resistance change from the transistor 42 can cause a small difference in the current and voltage on the phase terminals of the stator 12. This change is not enough to meaningfully impact operation of the motor 10, but is measurable. In other words, resistance modulation by the transistor 42 allows a signal to be embedded in the resulting current/voltage ripple on the stator 12. By opening and closing the transistor 42 rapidly, it is possible to encode information into the pulse pattern. Encoding may include any category of pulse modulation, including PWM or PFM. If multiple switched transistors and locations 28, 32 are used, the signal may not necessarily be binary. The information transmitted by the transistor 42 can also be packetize with checksum.

The telemetry device 20 further includes power regulator 44 and control logic 46. The power regulator 44 can for example be a linear voltage regulator, a switch mode voltage regulator, a boost converter, or a buck converter. The power regulator 44 can store enough energy to power the control logic 46 and the sensors 22 when the transistor 42 is closed. The control logic 46 can for example be a microprocessor or an analog circuit. The control logic 46 converts the outputs of the sensors 22 to into pulse modulation signals for being transmitted by transistor 42.

Controller 24 is configured to obtain information about the voltage and/or current of the phase terminals of the stator 12. The controller 24 can filter the measured signals via high pass, low pass or notch pass filtering, and can demodulate the filtered signal to obtain the transmitted information. The transmitted information is then used to achieve or refine a control loop of the motor 10 during operation, allowing higher efficiency, higher power density and/or peak power.

A method of controlling the induction motor 10 can include powering the telemetry device 20 by the voltage difference between the locations 26, 32 of the rotor bar assembly 16, measuring, by the at least one sensor 22, a temperature and/or a voltage along the rotor bar assembly 16 and wirelessly transmitting, by the telemetry device 20, the temperature and/or the voltage to the controller 24. The method can also include modulating, by the controller 24, a flow of electrical current in and out of phase terminals 40 of the stator 12 as a function of the temperature and/or the voltage.

A method of constructing an induction motor rotor assembly can include fixing the telemetry device 20 to the rotor 14, electrically connecting the telemetry device 20 to the first location 28 of the rotor bar assembly 16 and to the second location 32 of the rotor bar assembly 16 axially offset from the first location 28 so the stator generates a voltage difference along the rotor bar assembly 16 during rotation of the rotor 14 by the magnetic field of the stator 12 inducing an electric current in the rotor bars 18. The method also includes fixing at least one sensor 22 to the rotor 14, and connecting the at least one sensor 22 to the telemetry device 20 for the telemetry device 20 to wirelessly transmit information from measurements of the at least one sensor 22 to the controller 24.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

### LIST OF REFERENCE NUMBERS

10 motor
12 stator
14 rotor
16 rotor bar assembly
18 rotor bars
20 telemetry device
22 at least one sensor
24 controller
26 first electrical connector
28 first location
30 second electrical connector
32 second location
34 metal core
36 rotor shaft
37 bearing
38 end segments
39 power electronics unit
40 phase terminals
42 transistor
44 power regulator
46 control logic

What is claimed is:

1. An induction motor comprising:
a stator;
a rotor configured for being rotated by the stator about a center axis, the rotor including a rotor bar assembly including a plurality of electrically conductive rotor bars;
a telemetry device fixed to the rotor, the telemetry device being electrically connected to the rotor bar assembly and powered by a voltage difference along the rotor bar assembly during rotation of the rotor about the center axis, the rotor being rotated by a magnetic field of the stator inducing an electric current in the rotor bars; and
at least one sensor fixed to the rotor for measuring a parameter of the rotor, the telemetry device configured for transmitting information representative of measurements of the at least one sensor to a controller located outside of the rotor.

2. The induction motor as recited in claim 1 wherein the telemetry device includes a first electrical connector connected to a first location of the rotor bar assembly and a second electrical connector connected to a second location of the rotor bar assembly, the first location having a different voltage than the second location.

3. The induction motor as recited in claim 2 wherein the first location and the second location are on a single one of the rotor bars, the second location being axially offset from the first location.

4. The induction motor as recited in claim 2 wherein the first location is on a first of the rotor bars and the second location being on a second of the rotor bars.

5. The induction motor as recited in claim 1 wherein the parameter of the rotor is a temperature.

6. The induction motor as recited in claim 1 wherein the rotor includes a metal core, the rotor bars being circumferentially spaced apart from each other by the metal core so that the rotor bars are contiguous with and extending along the metal core.

7. The induction motor as recited in claim 6 wherein the rotor includes a rotor shaft, the metal core and the rotor bars being supported on the rotor shaft, the telemetry device being fixed to the rotor shaft.

8. The induction motor as recited in claim 6 wherein the at least one sensor is fixed to the rotor shaft, the rotor bars or a bearing of the rotor shaft.

9. The induction motor as recited in claim 1 further comprising a power electronics unit fixed with respect to the stator, the power electronics unit including the controller, the controller configured to modulate a current flow in and out of phase terminals of the stator in response to measurements of the at least one sensor.

10. The induction motor as recited in claim 1 wherein the information representative of measurements of the at least one sensor transmitted to the controller is transmitted via a voltage and/or a current of the phase terminals, the controller configured to modulate the current flow in and out of phase terminals of the stator in response to the obtained information about the voltage and/or current of the phase terminals.

11. The induction motor as recited in claim 1 wherein the telemetry device is configured for transmitting the information representative of measurements of the at least one sensor to the controller by a varying the electrical connection to the rotor bar assembly.

12. The induction motor as recited in claim 11 wherein the telemetry device includes a switched transistor configured to vary the electrical connection to the rotor bar assembly by opening and closing.

13. The induction motor as recited in claim 12 wherein the switched transistor encodes the information from the measurements into a pulse pattern is opened and closed in accordance with the pulse pattern.

14. A method of controlling an induction motor, the induction motor comprising:
a stator;
a rotor configured for being rotated by the stator about a center axis, the rotor including a rotor bar assembly including a plurality of electrically conductive rotor bars;
a telemetry device fixed to the rotor, the telemetry device being electrically connected to the rotor bar assembly and powered by a voltage difference along the rotor bar assembly during rotation of the rotor about the center axis, the rotor being rotated by a magnetic field of the stator inducing an electric current in the rotor bars; and
at least one sensor fixed to the rotor for measuring a parameter of the rotor, the telemetry device configured for transmitting information representative of measurements of the at least one sensor to a controller located outside of the rotor, the method comprising:
powering the telemetry device by the voltage difference;
measuring, by the at least one sensor, the parameter of the rotor; and
transmitting, by the telemetry device, information representative of measurements of the at least one sensor to the controller.

15. The method as recited in claim 14 further comprising modulating, by the controller, a flow of electrical current in and out of phase terminals of the stator as a function of the temperature and/or the voltage.

16. A method of constructing an induction motor rotor assembly comprising:
fixing a telemetry device to a rotor configured for being rotated by a stator about a center axis, the rotor including a rotor bar assembly including a plurality of electrically conductive rotor bars;
electrically connecting the telemetry device to a first location of the rotor bar assembly and to a second location of the rotor bar assembly so the stator generates a voltage difference along the rotor bar assembly during rotation of the rotor by a magnetic field of the stator inducing an electric current in the rotor bars; and
fixing at least one sensor to the rotor;
connecting the at least one sensor to the telemetry device for the telemetry device to transmit information representative of measurements of the at least one sensor to a controller located outside of the rotor.

17. The method as recited in claim 14 wherein the first location and the second location are on a single one of the rotor bars.

18. The method as recited in claim 14 wherein the first location is on a first of the rotor bars and the second location being on a second of the rotor bars.
